(19) United States
(12) Patent Application Publication
(10) Pub. No.: US 2015/0072267 A1
(43) Pub. Date: Mar. 12, 2015

(54) ENERGY HARVESTING WITH FLOW-THROUGH POROUS ELECTRODES

(71) Applicants: The Board of Trustees of the Leland Stanford Junior University, Palo Alto, CA (US); Lawrence Livermore National Security, LLC, Livermore, CA (US)

(72) Inventors: Matthew Suss, Cambridge, MA (US); Theodore F. Baumann, Discovery Bay, CA (US); Francesco Fornasiero, Oakland, CA (US); Michael Stadermann, Pleasanton, CA (US); Juan G. Santiago, Stanford, CA (US)

(21) Appl. No.: 14/024,540

(22) Filed: Sep. 11, 2013

(51) Int. Cl. H01M 8/08

(52) U.S. Cl. CPC H01M 8/08
USPC 429/499

(57) ABSTRACT

An apparatus for harvesting energy from fresh water and salt water, including a first porous electrode having first pores, a second porous electrode having second pores, a non-conducting permeable separator between the first porous electrode and the second porous electrode, a system for applying an electric potential difference between the first porous electrode, and the second porous electrode, and a system for flowing the fresh water and the salt water through the first porous electrode having first pores, through the non-conducting permeable separator, and through the second porous electrode having second pores thereby harvesting energy from the fresh water and the salt water.

### STATEMENT AS TO RIGHTS TO INVENTIONS MADE UNDER FEDERALLY SPONSORED RESEARCH AND DEVELOPMENT

The United States Government has rights in this invention pursuant to Contract No. DE-AC52-07NA27344 between the United States Department of Energy and Lawrence Livermore National Security, LLC for the operation of Lawrence Livermore National Laboratory.

### BACKGROUND

1. Field of Endeavor

The present invention relates to energy harvesting and more particularly to energy harvesting with flow-through porous electrodes.

2. State of Technology

State of the art devices (so called “electro-diffusion” devices), utilize flow between electrodes, resulting in diffusion-limited performance. Applicants utilize flow-through electrodes to remove diffusion limitations and enable significant performance enhancements.

The article “Extracting Renewable Energy from a Salinity Difference Using a Capacitor” by Doriano Brogioli in the journal “Physical Review Letters” PRL 103, 058501, Jul. 31, 2009 includes the state of technology information reproduce below.

A massive dissipation of free energy takes place at the estuary of rivers: fresh and salt water mix, giving rise to the less ordered state constituted by water of uniform salinity, thus dissipating about 2.2 kJ of free energy per liter of fresh water dispersed into the sea. Since the 1970s, it has been recognized that it is possible to interpose a suitable device between the flow of fresh water and the salt water, in order to exploit the free energy connected with the salinity difference as a completely renewable energy source. Already described techniques are pressure-retarded osmosis, based on semipermeable membranes, reverse electrodialysis, based on ion selective membranes, concentration electrochemical cells, devices exploiting difference in vapor pressure. Such devices generate a power of the order of 1 kW with a fresh water flow of 1 1=s.
Here I propose a novel method that can make practical applications feasible, based on electric double-layer (EDL) capacitor technology. The EDL capacitor is constituted by activated carbon electrodes immersed in sea water. It stores the charge in the EDLs constituted by counter ion distributions close to the electrode surfaces. Following the method here proposed, the salt solution is then brought into contact with fresh water. Salt ions diffuse away from the electrodes, against the electrostatic force: the electrostatic energy of the whole system increases.

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides a system utilizing flow-through porous electrodes. This system performs energy harvesting through electric double layer (EDL) expansion/contraction caused by alternating flows of salt and fresh water through the electrodes pores. The present invention has use in energy and power generation, green energy sources, desalination plants, and portable energy harvesting.

In one embodiment the present invention provides an apparatus for harvesting energy from fresh water and salt water, including a first porous electrode having first pores, a second porous electrode having second pores, a non-conducting permeable separator between the first porous electrode and the second porous electrode, a system for applying an electric potential difference between the first porous electrode, and the second porous electrode, and a system for flowing the fresh water and the salt water through the first porous electrode having first pores, through the non-conducting permeable separator, and through the second porous electrode having second pores thereby harvesting energy from the fresh water and the salt water. This provides a method of harvesting energy from fresh water and salt water, including the steps of providing a porous electrode having first pores, providing a second porous electrode having second pores, providing a non-conducting permeable separator between the first porous electrode and the second porous electrode, applying an electric field between the first porous electrode and the second porous electrode, and alternately flowing the fresh water and the salt water through the first pores of the first porous electrode, the second pores of the second porous electrode, and the separator for harvesting energy from the fresh water and salt water.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 illustrates a prior art “Flow Between” energy harvesting system wherein water flows through a gap between electrodes.

FIGS. 2A and 2B illustrate Applicant's “Flow Through” energy harvesting system wherein water flows through the pores of a pair of electrodes.

FIG. 3 illustrates Applicant's “Flow Through” energy harvesting system wherein water flows through the pores of a pair of electrodes.

FIG. 4 is a flow chart describing Applicant's “Flow Through” energy harvesting system.

FIG. 5 illustrates Applicant's “Flow Through” energy harvesting system using river water and sea water.

FIG. 6 illustrates Applicant's “Flow Through” energy harvesting system wherein water flows through the pores of a pair of electrodes.

FIG. 7 is a flow chart illustrating a method of energy harvesting wherein water flows through the pores of a pair of electrodes.

### DETAILED DESCRIPTION OF SPECIFIC EMBODIMENTS

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

The present invention provides a system using two charged, electrically conductive porous electrodes to perform energy harvesting through electric double layer (EDL) expansion/contraction. In the energy harvesting system, the two porous electrodes sandwich a porous dielectric separator material. A voltage is applied across the two porous electrodes, thus charging them and driving the uptake of ions into pore EDLs. In Applicant's system, subsequent to charging, an alternating flow of fresh and salt water is driven through the electrodes themselves, either parallel to or perpendicular to, the applied electric field. The changing bulk salinity drives EDL expansion/contraction cycles, which initiates an electric current in an external circuit, and it can be used to deliver power to a load.

The present invention uses flow-through electrodes, where a liquid stream flows directly through the pore structure of the electrodes. The prior art involved flowing liquid between electrodes. Applicants' “flow-through” energy harvesting system involves alternatingly flowing salt water and fresh water through the pores of a pair of monolithic porous electrodes. By alternatingly flowing salt water and fresh water through the pores of the electrodes, Applicant's system provides energy harvesting. Applicants have developed a technique of performing energy harvesting utilizing porous conductors such as activated carbon aerogels. In one embodiment Applicants' invention provides an energy harvesting apparatus including a first porous electrode conductor having first pores, a second porous electrode conductor having second pores, a porous insulator between the first porous electrode conductor and the second porous electrode conductor, a system for producing an applied electric field proximate the first porous electrode conductor and the second porous electrode conductor, and a system for alternatingly flowing salt water and fresh water through the first pores and the second pores of the first porous electrode conductor and the second porous electrode conductor.

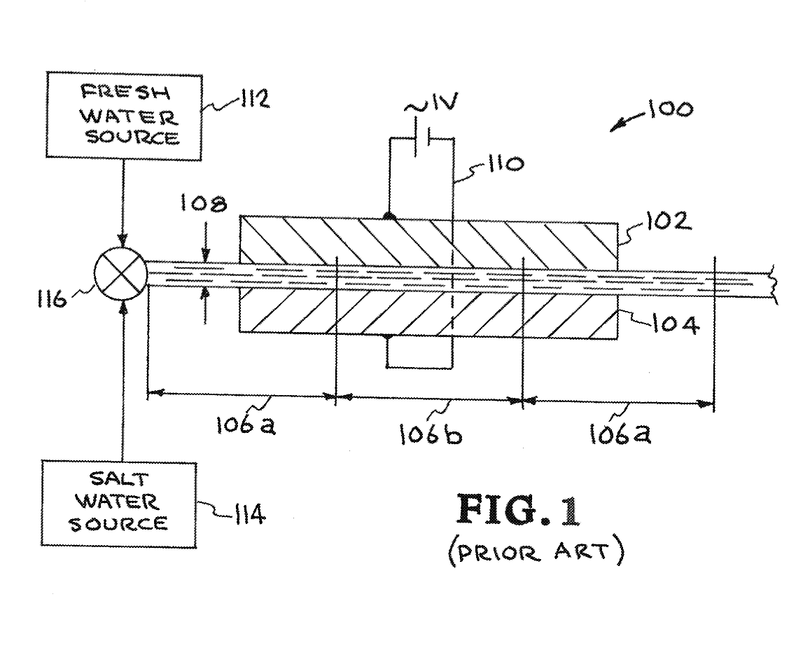

Referring now to the drawings and in particular to FIG. 1, a prior art system 100 is illustrated. In the prior art system 100 a pair of electrodes 102 and 104 are positioned to provide a gap 108 between the electrodes 102 and 104. A flow of water, fresh water portion 106A and salt water portion 106B, is directed thorough the gap 108. The fresh water source 112 and the salt water source 114 provide the alternating portions of fresh water 106a and salt water 106b. A valve 116 is used to switch between the fresh water source 112 and the salt water source 114 to provide the alternating portions of fresh water 106a and salt water 106b. An electrical circuit 110 energizes the electrodes 102 and 104 producing an electrical field acting on the fresh water 106A and salt water 106B.

FIG. 1 illustrates a prior art “Flow Between” energy harvesting system wherein water flows through the gap between electrodes to which a potential difference is applied. The “Flow Between” energy harvesting system is described in the article “Extracting Renewable Energy from a Salinity Difference Using a Capacitor” by Doriano Brogioli in the journal “Physical Review Letters” PRL 103, 058501, Jul. 31, 2009 as:

“An analogy can help to describe the physical principle of the method. Consider an electrostatic capacitor, made of two conductive plates with a solid dielectric medium in between, which can be inserted or extracted. When the plates constituting the capacitor are charged, the electrostatic force attracts and keeps the dielectric medium inside the capacitor. The work done to extract the dielectric is converted into electrostatic energy, appearing as an increase of voltage between the plates, while the accumulated charge remains constant. This kind of device is thus able to transform mechanical work into electrostatic energy.”
“The dielectric medium of the capacitor described in this Letter is substituted by salt water. After the capacitor has been charged, the solution is brought into contact with fresh water, so that salt ions diffuse away from the capacitor. I will show that, in analogy with the previous case, the ion removal, performed by diffusion, increases the voltage between the plates, at the expense of free energy of the two solutions involved in the process, namely, salt and fresh water.”

The present invention provides a “Flow Through” energy harvesting system by alternatingly flowing salt water and fresh water through the pores of a pair of electrodes. An applied electric field is applied proximate the first porous electrode and the second porous electrode. One important advantage of Applicant's Flow Through energy harvesting system is that it has a much higher power output than the prior art flow between system because with Applicant's Flow Through system you can flush out the water instead of waiting for ions to diffuse. This reduced the equilibration time by a factor of 10-100 or more.

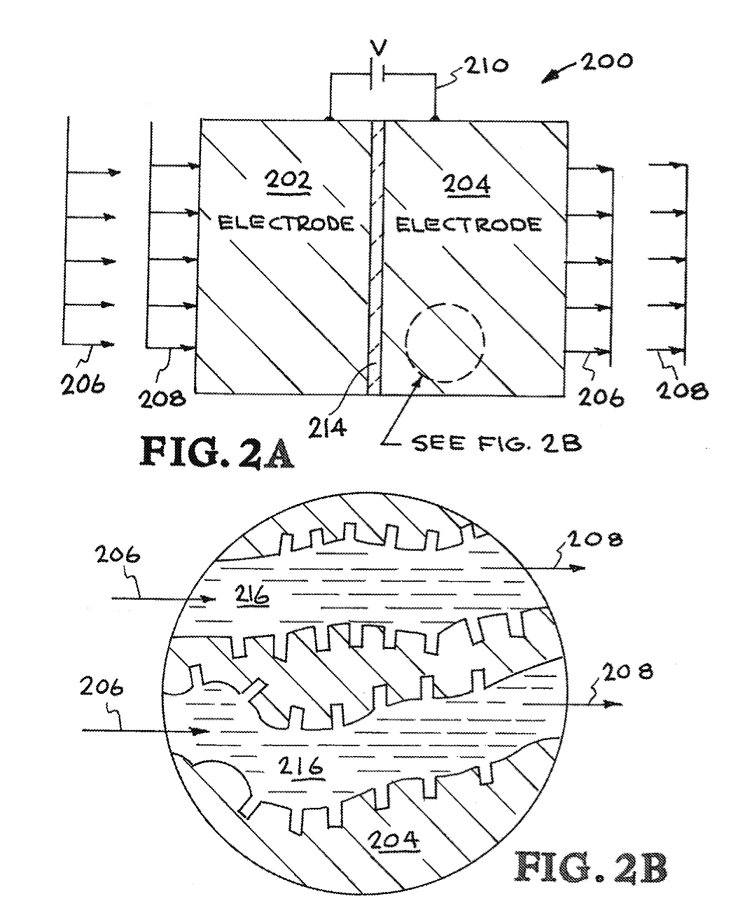

Referring now to FIGS. 2A and 2B, Applicant's invention utilizing flow-through porous electrodes is illustrated in various embodiments by the system 200. The system 200 performs energy harvesting through electric double layer (EDL) expansion/contraction caused by alternating flows of salt and fresh water through the electrodes pores. The liquid stream flows directly through the pore structure of the electrodes. Prior art involved instead flowing liquid between electrodes and through the porous separator layer. In one embodiment the system 200 uses porous electrodes with a hierarchical pore structure, which enables both efficient flow through the electrode and high capacitance (high surface area). In one embodiment the system 200 uses a thin separator to electrode thickness ratio, which vastly helps device performance, and is enabled by the fact that our separator is not the primary flow channel.

Referring now specifically to FIG. 2A, Applicant's “Flow Through” system 200 is illustrated having a pair of electrodes 202 and 204 located so that a flow of feed water, illustrated by the arrows 206 and 208, flows through the electrodes 202 and 204. A thin porous separator 114 made of a dielectric material to prevent electrical shorts is located between electrodes 202 and 204. Applicants' “flow-through” system 200 operates by alternatingly flowing fresh water 206 and salt water 208 through the pores of a pair of monolithic porous electrodes 202 and 204. The alternate flowing of fresh water 206 and salt water 208 is illustrated by the arrows 206 and 208. An electrical circuit 210 energizes the electrodes 202 and 204 producing an electrical field acting on the feed water 206 and 208.

Referring now specifically to FIG. 2B, the electrodes 202 and 204 include pores 216 through which the flow of feed water 206 & 208 flows. The micron scale pores 216 allow for fluid flow 206 directly through the electrode 204 while the nano-scale pores 216 provide high surface area for adsorption of ions.

In Applicant's “Flow Through” system 200, subsequent to charging, an alternating flow of fresh water 206 and salt water 208 is driven through the electrodes 202 & 204 themselves, either parallel to or perpendicular to, the applied electric field. The changing bulk salinity drives EDL expansion/contraction cycles, which initiates an electric current in an external circuit, and this is used to deliver power to a load.

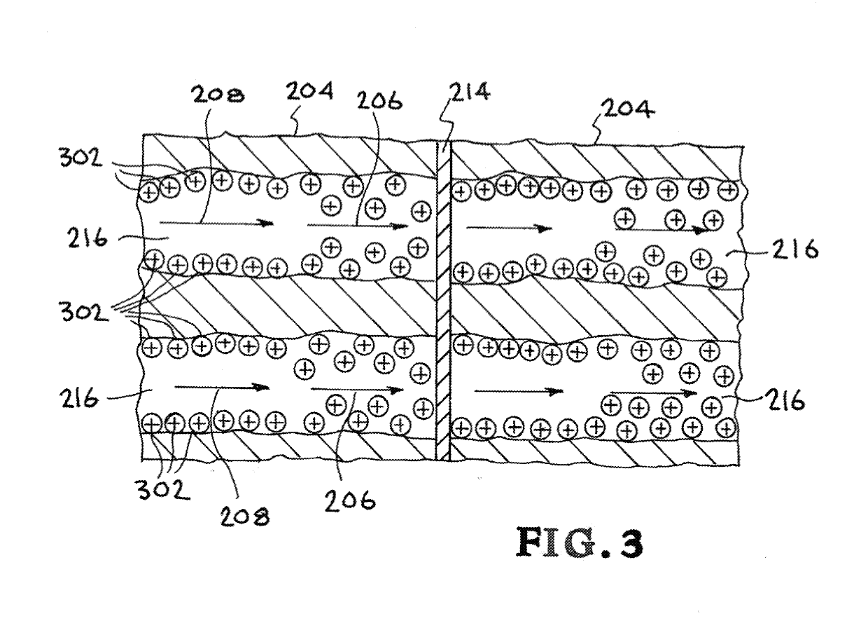

Referring now to FIG. 3, the operation of Applicant's energy harvesting system 200 will be described. The feed water, illustrated by the arrows 206 and 208, flows through the electrode 204 and the thin porous separator 114. Applicant's system operates by alternatingly flowing fresh water 206 and salt water 208 through the pores of the porous electrode 204. The electrode 204 includes pores 216 through which the flow of feed water 206 & 208 flows. The micron scale pores 216 allow for fluid flow 206 directly through the electrode 204 while the nano-scale pores 216 provide high surface area for adsorption of ions 302. The changing bulk salinity drives EDL expansion/contraction cycles, which initiates an electric current in an external circuit, and this is used to deliver power to a load.

In one embodiment the porous electrode 204 is produced by depositing polystyrene beads in a closed packed, ordered structure using electrophoretic deposition, backfilling the template with polymer or nickel, and then removing the template. Polymer structures were then further carbonized. Structures with various pore sizes and thicknesses were created. In one embodiment the porous electrode 204 is produced with transport pores with diameter greater than 500 nm for effecting transport of the target salt solution and adsorption pores with diameter less than 100 nm. In another embodiment the porous electrode 204 is made of carbon. In yet another embodiment the porous electrode 204 is made of carbon aerogel. In one embodiment the non-conducting permeable separator has a width that is less than 100 μm thick. In another embodiment the non-conducting permeable separator has a width and said width is between 20 μm and 100 μm. In yet another embodiment the porous electrode has an electrode width and the non-conducting permeable separator has a width that is less forty percent of the electrode width.

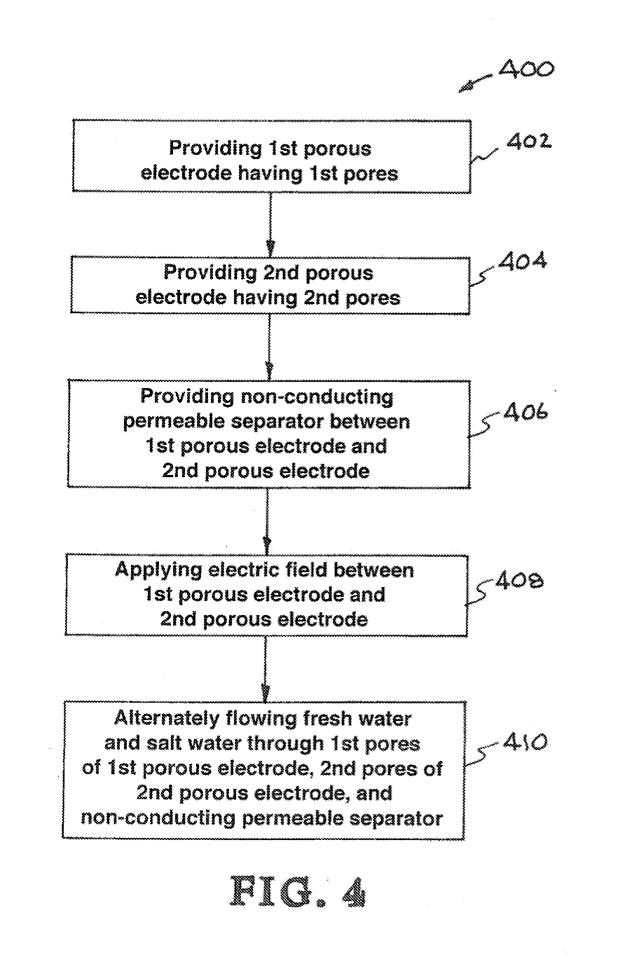

Referring now to FIG. 4, a flow chart describes Applicant's “Flow Through” energy harvesting system. The system is designated generally by the reference numeral 400. The system 400 provides a method of harvesting energy from fresh water and salt water. The method 400 includes the following steps:
Step #1 (402)—Providing a porous electrode having first pores.
Step #2 (404)—Providing a second porous electrode having second pores.

Step #3 (406)—Providing a non-conducting permeable separator between said first porous electrode and said second porous electrode.

Step #4 (408)—Applying an electric field between said first porous electrode and said second porous electrode.

Step #5 (410)—Alternately flowing the fresh water and the salt water through said first pores of said first porous electrode, said second pores of said second porous electrode, and said separator for harvesting energy from the fresh water and salt water.

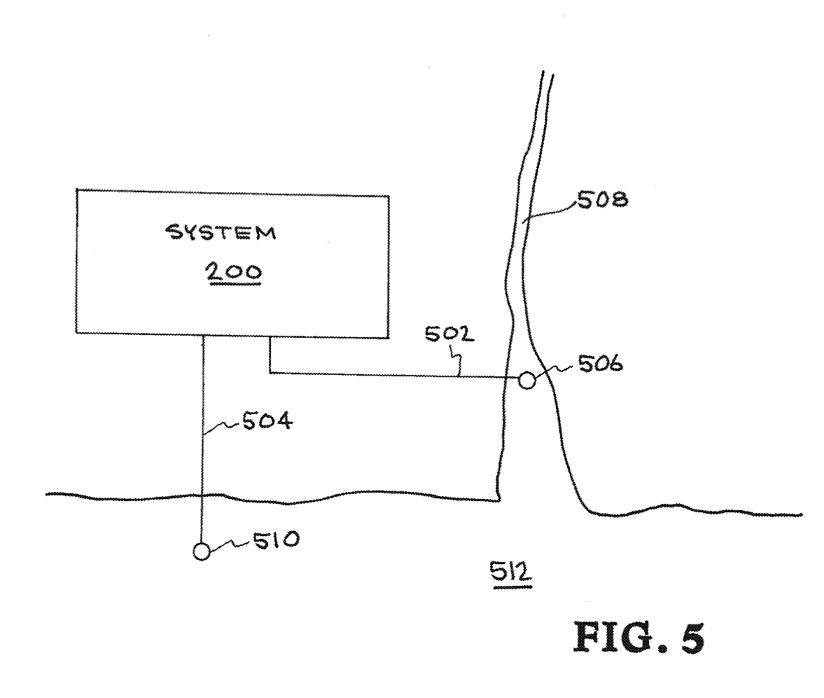

Referring now to FIG. 5, one embodiment of Applicant's invention utilizing flow-through porous electrodes for harvesting energy from fresh water and salt water is illustrated. This embodiment is designated generally by the reference numeral 500.

Harvesting energy from sea water with fresh water as found at the mouths of rivers is a sustainable source of energy. The naturally occurring availability of sea water and fresh water can be found at the mouth of any river and has the potential to be utilized as a cheap and continuous source of energy. The amount of energy that can be harvested in such a location is potentially very large. For example, big rivers like the Mississippi have flow rates averaging 10,000,000 l/s.

Applicants' system 500 operates by alternatingly flowing river water 502 and sea water 504 through the pores of a pair of monolithic porous electrodes. As illustrated in FIG. 5, a river water source is provided by a river water intake 506 on a river 508. A sea water source is provided by a sea water intake 510 on an ocean 512.

The river water 502 and sea water 504 are directed to a system 200 constructed as previously described. Applicants' “flow-through” energy harvesting system involves alternatingly flowing the sea water 504 and the river water 502 through the pores of a pair of monolithic porous electrodes. By alternatingly flowing sea water and river water through the pores of the electrodes. Applicant's system provides energy harvesting.

The system 200 uses charged, electrically conductive porous electrodes to perform energy harvesting through electric double layer (EDL) expansion/contraction. In the energy harvesting application, the two porous electrodes sandwich a porous dielectric separator material. A voltage is applied across the two porous electrodes, thus charging them and driving the uptake of ions into pore EDLs. In Applicant's device, subsequent to charging, an alternating flow of river and sea water is driven through the electrode themselves, either parallel to or perpendicular to, the applied electric field. The changing bulk salinity drives EDL expansion/contraction cycles, which initiates an electric current in an external circuit, and this can be used to deliver power to a load.

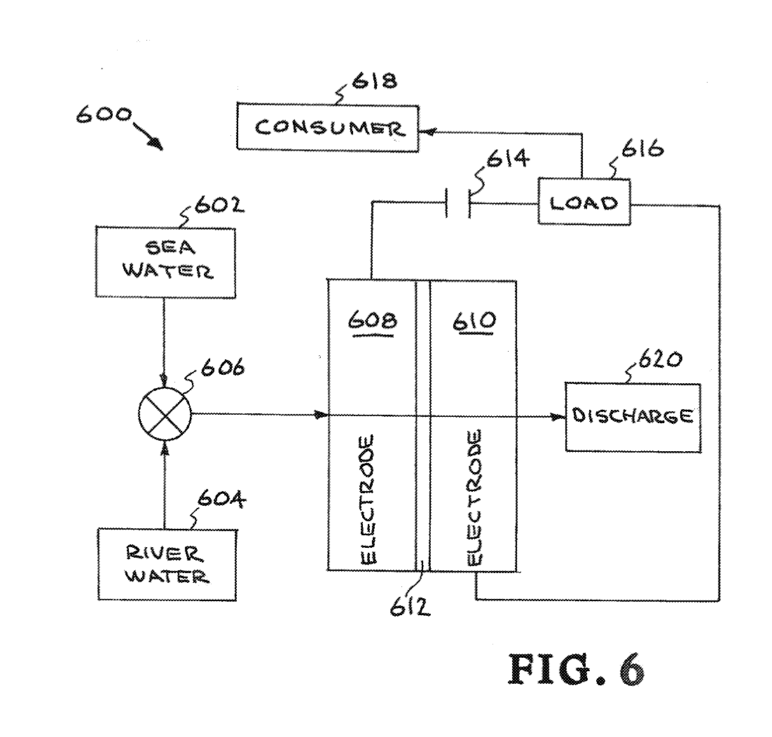

Referring now to FIG. 6, Applicant's invention utilizing flow-through porous electrodes for harvesting energy from fresh water and salt water is further illustrated. This embodiment is designated generally by the reference numeral 600.

Harvesting energy from sea water and fresh water, as found at the mouths of rivers, is a sustainable source of energy. Applicants' system 600 operates by alternatingly flowing river water 602 and sea water 604 through the pores of a pair of monolithic porous electrodes 608 and 610. A valve 606 is used to switch between the river water 602 and sea water 604 to provide alternating portions of river water 602 and sea water 604 flowing through the porous electrodes 608 and 610. The flow continues to the discharge 620.

An electrical circuit 614 energizes the electrodes 608 and 610 producing an electrical field acting on the fresh water 602 and salt water 604. By alternatingly flowing the sea water 604 and the river water 602 through the pores of the electrodes, Applicant's system provides energy harvesting. This electrical energy is available to the consumer 618 as load 616.

The system 200 uses charged, electrically conductive porous electrodes to perform energy harvesting through electric double layer (EDL) expansion/contraction. In the energy harvesting application, the two porous electrodes sandwich a porous dielectric separator material. A voltage is applied across the two porous electrodes, thus charging them and driving the uptake of ions into pore EDLs. In Applicant's device, subsequent to charging, an alternating flow of river and sea water is driven through the electrode themselves, either parallel to or perpendicular to, the applied electric field. The changing bulk salinity drives EDL expansion/contraction cycles, which initiates an electric current in an external circuit, and this can be used to deliver power to the load 616.

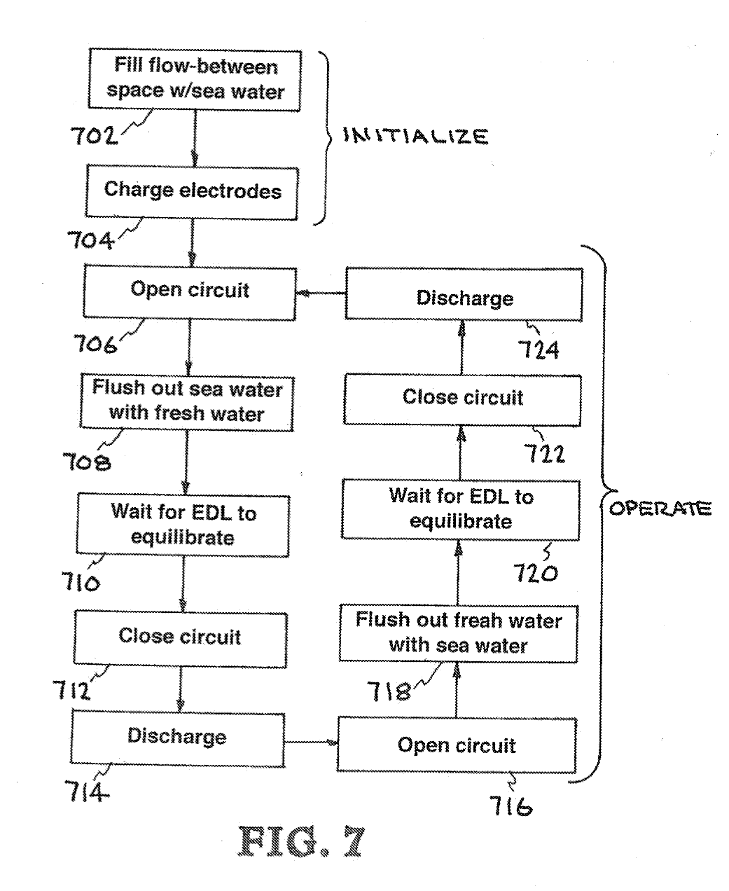

Referring now to FIG. 7, a flow chart illustrates one embodiment of Applicant's “Flow Through” energy harvesting method. The method is designated generally by the reference numeral 700. The method 700 provides a method of harvesting energy from fresh water and salt water using electric double layer (EDL) expansion/contraction caused by alternating flows of sea and fresh water through the electrodes' pores. One important advantage of the method 700 is that it provides a source of alternating current by periodically alternating the input of fresh water and salt water. The two solutions of sea and fresh water with different salinities are alternately directed the electrodes' pores producing alternating current.

As illustrated in FIG. 7, the method 700 involves the basic processes of initialization and operation. The method 700 includes the following steps:
Step 702—Fill flow-between space with sea water.
Step 704—Charge electrodes.
Step 706—Open Circuit.
Step 708—Flush out sea water with fresh water.
Step 710—Wait for EDL to equilibrate.
Step 712—Close circuit.
Step 714—Discharge.
Step 716—Open circuit.
Step 718—Flush out fresh water with sea water.
Step 720—Wait for EDL to equilibrate.
Step 722—Close circuit.
Step 724—Discharge.

The method 700 has fewer steps than the prior art method due to the superior power performance of the setup. In the prior art method the flow-between is limited by the EDL equilibration, which is slow. Applicant's Flow-Through method 700 dramatically speeds up equilibration and is limited by the RC time constant (the charge/discharge rate of the capacitor). If the capacitor is made thinner, the charge time decreases, and the device gets even faster.

Applicants' invention provides a method of harvesting energy from fresh water and salt water. The method includes the steps of providing a porous electrode having first pores, providing a second porous electrode having second pores, providing a non-conducting permeable separator between the first porous electrode and the second porous electrode, applying an electric field between the first porous electrode and the second porous electrode, and alternately flowing the fresh water and the salt water through the first pores of the first porous electrode, the second pores of the second porous electrode, and the separator for harvesting energy from the fresh water and salt water. In one embodiment the fresh water is river water. In one embodiment the fresh water is municipal waste. In one embodiment the salt water is ocean water. In one embodiment the salt water is urine.

Although the description above contains many details and specifics, these should not be construed as limiting the scope of the invention but as merely providing illustrations of some of the presently preferred embodiments of this invention. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present invention fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present invention, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is

1. An apparatus for harvesting energy from fresh water and salt water, comprising:
a first porous electrode having first pores,
a second porous electrode having second pores,
a on-conducting permeable separator between said first porous electrode and said second porous electrode,
a system for applying an electric potential difference between said first porous electrode, and said second porous electrode, and
a system for flowing the fresh water and the salt water through said first porous electrode having first pores, through said non-conducting permeable separator, and
through said second porous electrode having second pores thereby harvesting energy from the fresh water and the salt water.

2. The apparatus for harvesting energy from fresh water and salt water of claim 1 wherein said non-conducting permeable separator has a width that is less than 100 μm thick.

3. The apparatus for harvesting energy from fresh water and salt water of claim 1 wherein said non-conducting permeable separator has a width and said width is between 20 μm and 100 μm.

4. The apparatus for harvesting energy from fresh water and salt water of claim 1 wherein said first porous electrode conductor has a first electrode conductor width and wherein said non-conducting permeable separator has a width that is less forty percent of said first electrode width.

5. The apparatus for harvesting energy from fresh water and salt water of claim 4 wherein said second porous electrode has a second electrode width and wherein said non-conducting permeable separator has a width that is less forty percent of said second electrode width.

6. The apparatus for harvesting energy from fresh water and salt water of claim 1 wherein said first pores of said first porous electrode having first pores comprise transport pores with diameter greater than 500 nm for effecting transport of the target salt solution and adsorption pores with diameter less than 100 nm.

7. The apparatus for harvesting energy from fresh water and salt water of claim 1 wherein said first porous electrode having first pores is made of carbon.

8. The apparatus for harvesting energy from fresh water and salt water of claim 1 wherein said second porous electrode having second pores is made of carbon.

9. The apparatus for harvesting energy from fresh water and salt water of claim 1 wherein said first porous electrode having first pores is made of carbon and wherein said second porous electrode having second pores is made of carbon.

10. The apparatus for harvesting energy from fresh water and salt water of claim 1 wherein said first porous electrode having first pores is made of carbon aerogel.

11. The apparatus for harvesting energy from fresh water and salt water of claim 1 wherein said first porous electrode having first pores and said second porous electrode having second pores are made of carbon aerogel.

12. The apparatus for harvesting energy from fresh water and salt water of claim 1 further comprising additional units of apparatus for harvesting energy from fresh water and salt water wherein said additional units of apparatus for harvesting energy from fresh water and salt water comprise a third porous electrode having third pores, a fourth porous electrode having fourth pores, an additional non-conducting permeable separator between said third porous electrode and said fourth porous electrode, a system for applying an electric potential difference between said third porous electrode, and said fourth porous electrode, and a system for flowing the fresh water and the salt water through said third porous electrode having third pores, through said additional non-conducting permeable separator, and through said fourth porous electrode having fourth pores.

13. A method of harvesting energy from fresh water and salt water, comprising the steps of:
providing a porous electrode having first pores,
providing a second porous electrode having second pores,
providing a non-conducting permeable separator between said first porous electrode and said second porous electrode,
applying an electric field between said first porous electrode and said second porous electrode, and
alternately flowing the fresh water and the salt water through said first pores of said first porous electrode, said second pores of said second porous electrode, and said separator for harvesting energy from the fresh water and salt water.

14. The method of harvesting energy from fresh water and salt water of claim 13 wherein said step of providing a separator between said first porous electrode and said second porous electrode comprises providing a non-conducting permeable separator that has a width and said width is less than 100 μm thick between said first porous electrode and said second porous electrode.

15. The method of harvesting energy from fresh water and salt water of claim 13 wherein said step of providing a first porous electrode having first pores comprises providing a first porous electrode having first pores wherein said first pores include transport pores with diameter greater than 500 nm for effecting transport of the fresh water and salt water with diameter less than 100 nm.

16. A method of harvesting energy, comprising the steps of:
providing fresh water,
providing salt water,
providing a porous electrode having first pores,
providing a second porous electrode having second pores,
providing a non-conducting permeable separator between said first porous electrode and said second porous electrode,
applying an electric field between said first porous electrode and said second porous electrode, and
alternately flowing said fresh water and said salt water through said first pores of said first porous electrode, said second pores of said second porous electrode, and said separator for harvesting energy.

17. The method of harvesting energy of claim 16 wherein said step of providing a separator between said first porous electrode and said second porous electrode comprises providing a non-conducting permeable separator that has a width and said width is less than 100 μm thick between said first porous electrode and said second porous electrode.

18. The method of harvesting energy of claim 16 wherein said step of providing a first porous electrode having first pores comprises providing a first porous electrode having first pores wherein said first pores include transport pores with diameter greater than 500 nm for effecting transport of the fresh water and salt water with diameter less than 100 nm.

19. The apparatus for harvesting energy of claim 16 wherein said fresh water is river water.

20. The apparatus for harvesting energy of claim 16 wherein said fresh water is municipal waste.

21. The apparatus for harvesting energy of claim 16 wherein said salt water is ocean water.

22. The apparatus for harvesting energy of claim 16 wherein said salt water is urine.

23. The apparatus for harvesting energy of claim 16 wherein said fresh water is river water and wherein said salt water is ocean water.
